(19) United States
(12) Patent Application Publication
(10) Pub. No.: US 2015/0100558 A1
(43) Pub. Date: Apr. 9, 2015

(54) Method, Apparatus and Computer Program Product for Similarity Determination in Multimedia Content

(71) Applicant: Nokia Corporation, Espoo (FI)

(72) Inventor: Lixin Fan, Tampere (FI)

(21) Appl. No.: 14/503,916

(22) Filed: Oct. 1, 2014

(30) Foreign Application Priority Data
Oct. 4, 2013 (GB) 1317574.0

(51) Int. Cl. G06F 17/30

(52) U.S. Cl. CPC G06F 17/30324; G06F 17/3033
USPC 707/698

(57) ABSTRACT

In an example embodiment, a method, apparatus and computer program product are provided. The method includes determining an upper bound on a probability of error associated with a mapping of a data into binary codes. The mapping is performed based on a plurality of hash functions. The method further includes selecting a set of hash functions from among the plurality of hash functions associated with a minimization of the upper bound on the probability of error.

### TECHNICAL FIELD

Various implementations relate generally to method, apparatus, and computer program product for similarity determination in multimedia content.

### BACKGROUND

Various electronic devices such as cameras, mobile phones, and other devices are now used for capturing and storing multimedia data. Examples of multimedia content may include, but are not limited to images, video files, audio files, text documents, and the like. Due to storage of vast amount of the multimedia content in electronic devices, various mechanisms have been devised that facilitate appropriate categorization of the multimedia data so that the multimedia data may be accessed conveniently. Although, electronic devices are capable of supporting applications that may categorize, store and manage the multimedia content, however, organizing or accessing the stored multimedia content involves longer duration of time and intensive computations.

### SUMMARY OF SOME EMBODIMENTS

Various aspects of example embodiments are set out in the claims.

In a first aspect, there is provided a method comprising: determining an upper bound on a probability of error associated with a mapping of a data into binary codes, the mapping being performed based on a plurality of hash functions; and selecting a set of hash functions from among the plurality of hash functions associated with a minimization of the upper bound on the probability of error.

In a second aspect, there is provided an apparatus comprising at least one processor; and at least one memory comprising computer program code, the at least one memory and the computer program code configured to, with the at least one processor, cause the apparatus to perform at least: determine an upper bound on a probability of error associated with a mapping of a data into binary codes, the mapping being performed based on a plurality of hash functions; and select a set of hash functions from among the plurality of hash functions associated with a minimization of the upper bound on the probability of error.

In a third aspect, there is provided a computer program product comprising at least one computer-readable storage medium, the computer-readable storage medium comprising a set of instructions, which, when executed by one or more processors, cause an apparatus to perform at least: determine an upper bound on a probability of error associated with a mapping of a data into binary codes, the mapping being performed based on a plurality of hash functions; and select a set of hash functions from among the plurality of hash functions associated with a minimization of the upper bound on the probability of error.

In a fourth aspect, there is provided an apparatus comprising: means for determining an upper bound on a probability of error associated with a mapping of a data into binary codes, the mapping being performed based on a plurality of hash functions; and means for selecting a set of hash functions from among the plurality of hash functions associated with a minimization of the upper bound on the probability of error.

In a fifth aspect, there is provided a computer program comprising program instructions which when executed by an apparatus, cause the apparatus to: determine an upper bound on a probability of error associated with a mapping of a data into binary codes, the mapping being performed based on a plurality of hash functions; and select a set of hash functions from among the plurality of hash functions associated with a minimization of the upper bound on the probability of error.

### BRIEF DESCRIPTION OF THE FIGURES

Various embodiments are illustrated by way of example, and not by way of limitation, in the figures of the accompanying drawings in which:

FIG. 1 illustrates a device, in accordance with an example embodiment;

FIG. 2 illustrates an example block diagram of an apparatus, in accordance with an example embodiment;

FIG. 3 illustrates an example representation of similarity determination based on divergence measure, in accordance with an example embodiment;

FIG. 4 is a flowchart depicting an example method for similarity determination, in accordance with an example embodiment;

FIG. 5 is a flowchart depicting an example method for similarity determination, in accordance with another example embodiment; and

FIG. 6 is a flowchart depicting an example method for similarity determination, in accordance with yet another example embodiment.

### DETAILED DESCRIPTION

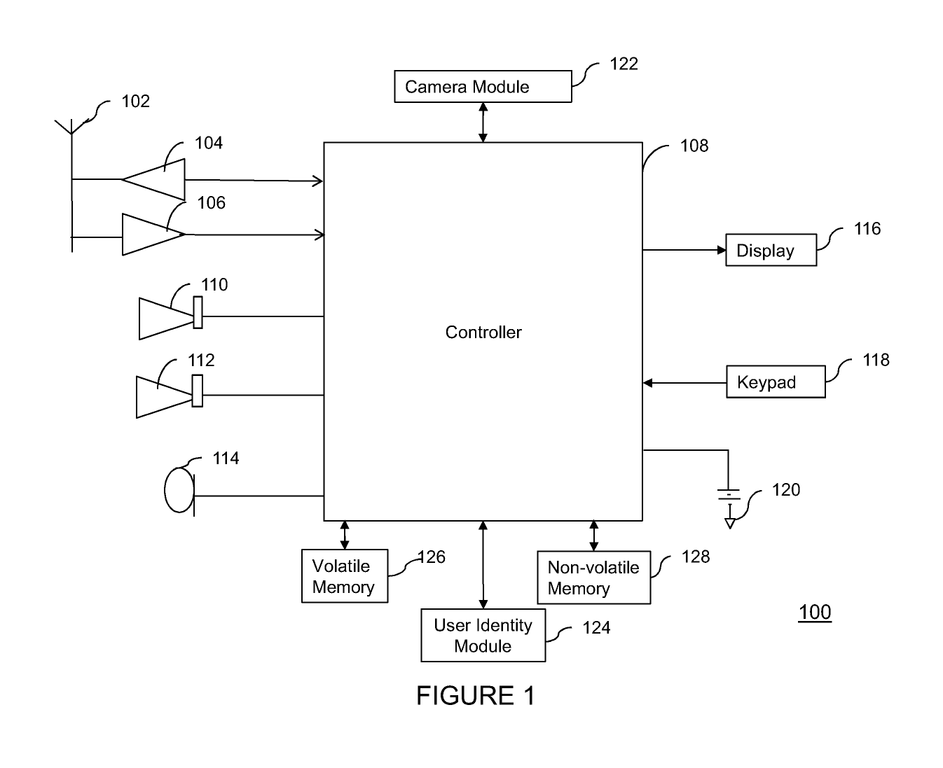

Example embodiments and their potential effects are understood by referring to FIGS. 1 through 6 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as Bluetooth® networks, Zigbee® networks, Institute of Electric and Electronic Engineers (IEEE) 802.11x networks, and the like; wire line telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media-capturing element, such as a camera, video and/or audio module, in communication with the controller 108. The media-capturing element may be any means for capturing an image, video and/or audio for storage, display or transmission. In an example embodiment in which the media-capturing element is a camera module 122, the camera module 122 may include a digital camera (or array of multiple cameras) capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100. Practically, the camera module(s) can also be on any side, but normally on the opposite side of the display 116 or on the same side of the display 116 (for example, video call cameras).

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

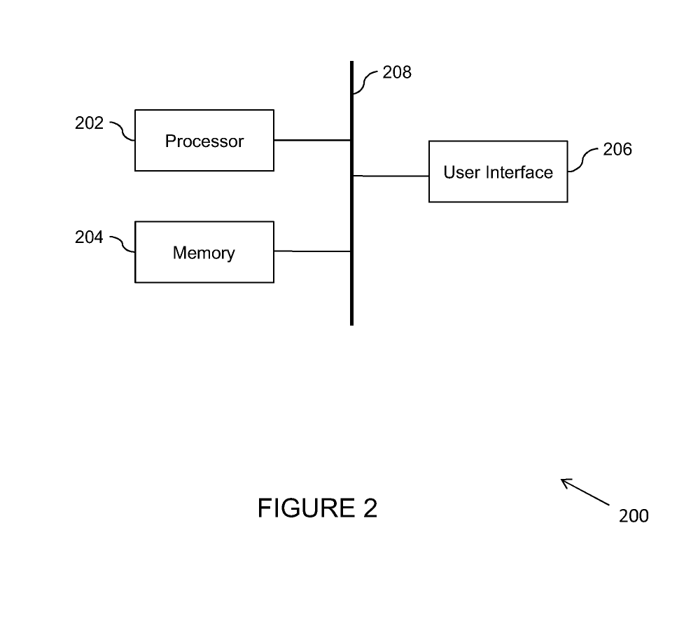

FIG. 2 illustrates an apparatus 200 for similarity determination in multimedia content, in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. Alternatively, embodiments may be employed on a combination of devices including, for example, those listed above. Accordingly, various embodiments may be embodied wholly at a single device, (for example, the device 100 or in a combination of devices. Furthermore, it should be noted that the devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory include, but are not limited to, random access memory, dynamic random access memory, static random access memory, and the like. Some examples of the non-volatile memory include, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the electronic device may include a mobile phone, a personal digital assistant (PDA), and the like. Some examples of computing device may include a laptop, a personal computer, and the like. Some examples of electronic device may include a camera. In an example embodiment, the electronic device may include a user interface, for example, the UI 206, having user interface circuitry and user interface software configured to facilitate a user to control at least one function of the electronic device through use of a display and further configured to respond to user inputs. In an example embodiment, the electronic device may include a display circuitry configured to display at least a portion of the user interface of the electronic device. The display and display circuitry may be configured to facilitate the user to control at least one function of the electronic device.

In an example embodiment, the electronic device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. Examples of media content may include audio content, video content, data, and a combination thereof.

In an example embodiment, the electronic device may be embodied as to include an image sensor. The image sensor may be in communication with the processor 202 and/or other components of the apparatus 200. The image sensor may be in communication with other imaging circuitries and/or software, and are configured to capture digital images or to capture video or other graphic media. The image sensor and other circuitries, in combination, may be example of at least one camera module such as the camera module 122 of the device 100.

These components (202-206) may communicate to each other via a centralized circuit system 208 to perform similarity determination in multimedia content such as images. The centralized circuit system 208 may be various devices configured to, among other things, provide or enable communication between the components (202-206) of the apparatus 200. In certain embodiments, the centralized circuit system 208 may be a central printed circuit board (PCB) such as a motherboard, main board, system board, or logic board. The centralized circuit system 208 may also, or alternatively, include other printed circuit assemblies (PCAs) or communication channel media.

In an example embodiment, the processor 202 is configured to, with the content of the memory 204, and optionally with other components described herein, to cause the apparatus 200 to perform similarity determination in a multimedia content. Various applications of similarity determination may include image classification, image identification, panorama generation, binary feature mapping, object recognition, image retrieval, local descriptor matching, and the like. In an example embodiment, similarity determination may be utilized for performing multimedia classification, for example by classifying a multimedia content such as an image into a category. In an embodiment, image classification may include mapping high dimensional image data into binary codes, thereby facilitating in efficient storing and searching of large-scale image databases for matching images. In an embodiment, image mapping may be performed to achieve indexing and fast matching of feature points associated with the image in large-scale multimedia databases.

In an embodiment, performing image mapping may include learning or modeling categories to classify the identified images into various categories. In an embodiment, the identified images may be classified into various categories by performing a search for a matching image associated with the identified image. In an embodiment, the learning may be supervised, semi-supervised or unsupervised learning. For example, in supervised learning the categorization may be performed by manually specifying the categories. Unsupervised learning pertains to the categorization by training images using a training model. In an embodiment, the learning may be formulated within a statistical learning framework for performing image classification.

In an example embodiment, the processor 202 is configured to, with the content of the memory 204, and optionally with other components described herein, to cause the apparatus 200 to formulate a binary hash code learning within a statistical learning framework. In an example embodiment, an upper bound of a probability of errors may be derived for different forms of hash functions. In an embodiment, the probability of error may be associated with an error, for example, Bayes decision error. In an embodiment, minimizing an upper bound for various hash code learning mechanisms, such as supervised learning mechanism and unsupervised learning mechanisms, may lead to consistent performance improvements in image classification.

In an embodiment, the processor 202 is configured to, with the content of the memory 204, and optionally with other components described herein, to cause the apparatus 200 to facilitate receipt of a data, for example an image data, that may be capable of being classified into one or more classes. In an embodiment, the data may be a multi-dimensional data. In the foregoing discussion, the term ‘data’ may refer to the multi-dimensional data associated with multimedia content. In an embodiment, a p-dimensional data (x) may be represented as:

x=(x₁, x₂, . . . , xₚ)ε [symbol] ^{p}

The data (x) may be associated with a class of a probable plurality of classes. For example, the data (x) may be associated with a class of M probable classes C₁, C₂, . . . C_{M}. In an embodiment, priori probabilities associated with the plurality of classes C₁, C₂, . . . C_{M} may be π₁, π₂ . . . π_{M}, and a probability density function associated with the plurality of classes may be given by p₁(x), p₂(x) . . . pₘ(x). As disclosed herein, the term ‘priori probability’ may refer to deducing a conclusion based on deductive reasoning rather than research. For example, the ‘priori probability’ of occurrence of an event selected from a set of M events may be 1/M. In an embodiment, a probability distribution may express an uncertainty associated with an event before a data is taken into account. In an embodiment, the probability distribution when multiplied by a likelihood function and normalized may give a posterior probability distribution.

In an embodiment, the multi-dimensional data may be mapped onto binary codes to facilitate in easy searching and management of the data. In an embodiment, the multi-dimensional data may be mapped onto the binary codes by utilizing a plurality of hash functions. A hash function may provide a solution for mapping a data (for example, the multidimensional data x) into a single bit binary code. In an embodiment, the binary codes comprise multi-bit strings, and the hash functions may map a high-dimensional vector data to M-bit binary codes.

In an embodiment, the processor 202 is configured to, with the content of the memory 204, and optionally with other components described herein, to cause the apparatus 200 to recursively partition a space, for example an Euclidean space [symbol] associated with the multi-dimensional data into a plurality of non-overlapping subsets. The non-overlapping subsets of the space may provide an efficient means for searching high-dimensional data. In an embodiment, the space [symbol] may be recursively partitioned into the plurality of subsets based on the plurality of hash functions.

In an embodiment, the hash function h: [symbol] ^{p}→{0,1} may represent a mapping of an the data (x) to a single bit binary code. In an embodiment, based on the outcome of the hash function, the processor 202 is configured to, with the content of the memory 204, and optionally with other components described herein, to cause the apparatus 200 to partition the sample space (S= [symbol] ^{p}) associated with the data into two complementary B-subsets that may be defined as follows:

[b]ₕ^{S}=(xεS|h(x)=b) b=0 or 1

By definition,

$${[ 0 ]}_{h}^{S} ⋃ {[ 1 ]}_{h}^{S} = S , \\ {[ 0 ]}_{h}^{S} ⋂ {[ 1 ]}_{h}^{S} = φ ,$$

and specifically, [φ]_{φ}^{s}=S

Herein, the definition of B-subsets may accommodate a plurality of hash functions associated with different families of hash functions, for example linear transform, kernelized or more complex hash functions. In an embodiment, a plurality of K hash functions H_{K}={h₁, h₂ . . . h_{K}} may partition the sample space S into 2^{K} non-overlapping subsets, which may be intersections of B-subsets of each hash functions:

[b₁, b₂ . . . b_{K}]_{H}_{ₖ}^{s}=[b₁]ₕ_{₁}^{S}∩[b₂]ₕ_{₂}^{S}∩ . . . [b_{K}]ₕ_{_{K}}^{S}

In an embodiment, each of the B-subsets [b₁, b₂ . . . b_{K}]_{H}_{_{K}}^{s} may be uniquely determined by a binary code [b₁, b₂ . . . b_{K}] and partitioning hash function H_{K} associated therewith. It will be noted that in certain scenarios when ambiguity seems unlikely, H_{K} and S may be omitted for the brevity of description, and binary codes may be denoted as [b_{1 . . . K}].

In an embodiment, the processor 202 is configured to, with the content of the memory 204, and optionally with other components described herein, to cause the apparatus 200 to determine a set of hash functions from among the plurality of hash functions that may be associated with minimization of a probability of error associated with the mapping. In an embodiment, the probability of error may pertain to a total probability of Bayes decision errors. In an embodiment, the set of hash functions (h_{K}*) that minimizes the total probability Pᵣ(e|H_{K}) of Bayes decision errors may be represented as:

h_{K}*=arg min_{H}_{_{K}}P(e|H_{K}) (1)

Herein, the total probability of Bayes decision errors may include probability of Bayes decision error associated with selecting a class, such as a class Cₘ that may be associated with a largest posterior probability. For example, the total probability of error for the plurality of hash functions H_{K} as below:

$${P}_{r} ( e \vert {H}_{K} ) = {\sum }_{{b}_{1 … K} ∈ {D}_{{H}_{k}}} P ( e \vert {b}_{1 … K} )$$

In an embodiment, the probability of the Bayes decision error for a binary code [b₁ b₂ . . . b_{K}] may be given by selecting the class Cₘ having the largest posterior probability:

$${P}_{r} ( e \vert {b}_{1 … K} ) = 1 - \frac{{π}_{m} {\int }_{{b}_{1 … K}} {p}_{m} ( X ) d X}{{\sum }_{i = 1}^{M} {π}_{i} {\int }_{{b}_{1 … K}} {p}_{i} ( X ) d X}$$

In an example embodiment, an upper bound on the probability of error P(e) may be utilized to supervise a variety of hash code learning algorithms. In an example embodiment, the processor 202 is configured to, with the content of the memory 204, and optionally with other components described herein, to cause the apparatus 200 to select a set of hash functions from among the plurality of hash functions associated with a minimization of the probability of error based on a divergence measure. In an example embodiment, the divergence measure may include Jensen Shannon Divergence (JSD) measure. In an example embodiment, the probability of error P(e) may be related to the JSD measure as below:

$$\begin{matrix} P ( e ) \leq \frac{1}{2} ( H ( π ) - J S {D}_{π} ( {p}_{1} … , {p}_{M} ) ) \\ where , \\ H ( π ) = - {\sum }_{i = 1}^{M} {π}_{i} ln {π}_{i} is the entropy of the priori probabilities , \\ and & ( 2 ) \\ \begin{matrix} J S {D}_{π} ( {p}_{1} … , {p}_{M} ) = H ( {\sum }_{i = 1}^{M} {π}_{i} {p}_{i} ) - {\sum }_{i = 1}^{M} {π}_{i} H ( {p}_{i} ) \\ = {\sum }_{i = 1}^{M} {π}_{i} KL ( {p}_{i} \vert \vert \overline{p} )\end{matrix} & ( 3 )\end{matrix}$$

Herein, JSD may be interpreted as weighted, by πᵢ, average of Kullback-Leibler divergences KL(pᵢ∥ p̅) between class distributions and a mixture distribution

$$\overline{p} = {\sum }_{i = 1}^{M} {π}_{i} {p}_{i}$$

Herein, the term mixture distribution may refer to a probability distribution of random variables, wherein values of the random variables may be assumed to be derived, for example from more than one parent population. For the plurality of hash functions H_{K}, JSD measure may be in discrete form, and may be compounded by summing over all B-subsets:

$$J S {D}_{π} ( {p}_{1} … , {p}_{M} \vert {H}_{K} ) = {\sum }_{{b}_{1 … K} ∈ {D}_{{h}_{K}}} J S {D}_{π} ( {p}_{1}^{{b}_{1 … K}} , … {p}_{M}^{{b}_{1 … K}} ) \\ where , \\ {p}_{1}^{{b}_{1 … K}} = {\int }_{{b}_{1 … K}} {p}_{i} ( X ) d X \qquad ( 4 )$$

In an embodiment, since H(π) is a constant for a given scenario, the upper bound of the probability of error may be minimized by maximizing equation (4):

h_{K}*=arg max_{H}_{_{K}}JSD_{π}(p₁ . . . , p_{M}|H_{K}) (5)

In an embodiment, increasing a number of hash functions in the set of hash functions may facilitate in maximizing the JSD measure associated with the set of hash function. For example, for a plurality of hash functions H_{K} having K hash functions, and a superset (H_{S}) of the set (H_{K}) of hash functions H_{S} having S hash functions such that H_{K}={h₁, h₂ . . . h_{K}} and H_{S}={h₁, h₂ . . . h_{K}, h_{S}}⊃H_{K},

then JSD_{π}(p₁ . . . , p_{M}|h_{K})<JSD_{π}(p₁, . . . p_{M}|h_{S}) provided pᵢ^{s}^{₁}/ p̅^̅{̅s̅}̅^̅{̅₁̅}̅=pᵢ^{s}^{₂}/ p̅^̅{̅s̅}̅^̅{̅₂̅}̅

This may be described as follows:

∀[b_{1 . . . K}]_{H}_{_{K}}=[b_{1 . . . K}]_{H}_{_{K}}∩([0]ₕ_{_{S}}∪[1]ₕ_{_{S}})=([0]ₕ_{_{S}}∩[b_{1 . . . K}]_{H}_{_{K}})∪([1]ₕ_{_{S}}∩[b_{1 . . . K}]_{H}_{_{K}}) [symbol] s₁∪s₂

Assuming without loss of generality that S₁≠, S₂≠, we have

$${p}_{i}^{b} {=}^{Δ} {p}_{i}^{{b}_{1 … K}} = {\int }_{s 1} {p}_{i} ( X ) d X + {\int }_{s 2} {p}_{i} ( X ) d X {=}^{Δ} {p}_{i}^{s 1} + {p}_{i}^{s 2}$$

$$\overline{{p}^{b}} {=}^{Δ} {\sum }_{i = 1}^{M} {\prod }_{i} {p}_{i}^{b} , \overline{{p}^{s 1}} {=}^{Δ} {\sum }_{i = 1}^{M} {\prod }_{i} {p}_{i}^{s 1} , \overline{{p}^{s 2}} {=}^{Δ} {\sum }_{i = 1}^{M} {\prod }_{i} {p}_{i}^{s 2} .$$

It then follows the log sum inequality that

pᵢ^{b} ln(pᵢ^{b}/ p̅^̅{̅b̅}̅)≦pᵢ^{s}^{₁} ln(pᵢ^{s}^{₁}/ p̅^̅{̅s̅}̅^̅{̅₁̅}̅)+pᵢ^{s}^{₂} ln(pᵢ^{s}^{₂}/ p̅^̅{̅s̅}̅^̅{̅₂̅}̅) (6)

with equality if and only if pᵢ⁸¹/ p̅⁸̅¹̅=pᵢ⁸²/ p̅⁸̅²̅
Summing up (6) left hand side (LHS) and right hand side (RHS) over all [b_{1 . . . K}]_{H}_{ₖ} and the plurality of classes (for example, M classes), it may be followed that:

∃[b_{1 . . . K}]ₕ_{_{K}}=s₁∪s₂ such that pᵢ^{s1}/ p̅^̅{̅s̅1̅}̅≠pᵢ^{s2}/ p̅⁸̅²̅

In an example embodiment, the processor 202 is configured to, with the content of the memory 204, and optionally with other components described herein, to cause the apparatus 200 to repeatedly compute and select new hash functions so as to maximize the JSD measure. In an example embodiment, the processor 202 is configured to, with the content of the memory 204, and optionally with other components described herein, to cause the apparatus 200 to utilize the learning model for learning a set of hash codes to determine similarity for supervising locality sensitive hashing (LSH).

In an embodiment, the framework for binary hash code learning may be applied to improve both supervised and unsupervised learning mechanisms. In an example embodiment, for applying to the unsupervised learning scenario, the multi-dimensional data (x) may be associated with multi-class labels. For example, the dataset (x) may contain N p-dimensional row vectors Xₙ as independent observations drawn from underlying multi-class distributions pᵢ. For example, the multi-dimensional image data may be represented by a dataset xε [symbol] ^{NX p} containing N p-dimensional row vectors xₙε [symbol] ^{IX p} n=1, . . . , N as independent observations drawn from underlying multi-class distributions pᵢ. In an embodiment, the priori probabilities may be directly estimated as πᵢ=Nᵢ/N, where Nᵢ is the number of data points that belong to each class. For each data point, the associated class label yₙ ε{1, . . . , M} may be derived. In an example embodiment, the class labels may be derived from Euclidean distance between the data points. In an alternative embodiment, the class label associated with the data points may be derived semantically, for example, provided by a human input.

In an embodiment, the framework for binary hash code learning may be utilized for supervising LSH for performing similarity search. In an embodiment, a linear dimensionality reduction may be applied to the data, and thereafter a binary quantization may be performed in the resulting space. In an embodiment, the processor 202 is configured to, with the content of the memory 204, and optionally with other components described herein, to cause the apparatus 200 to randomly generate a set of candidate linear projections. In an embodiment, the processor 202 is configured to, with the content of the memory 204, and optionally with other components described herein, to cause the apparatus 200 to apply the randomly generated set of linear projections to a data associated with the multi-dimensional observation to generate a binary matrix. For example, a set of L candidate linear projections wₗε [symbol] ^{PXI} l=1, . . . L may be randomly generated and applied to the whole dataset h₁=sgn(xwₗ). The outcome of the linear projections may be concatenated into a binary matrix Hε{0,1}^{NxL}.

In an embodiment, the data may be rearranged according to the classes such that the candidate binary matrix may be partitioned into separate matrices (column vectors) Hᵢε{0,1}ᵢ^{NxL} for each class associated with multi-class labels. In an embodiment, a class distribution may be determined based on the binary codes. In an embodiment, a set of binary vectors associated with the data may be determined. In an embodiment, each binary vector of the set of binary vectors may be associated with a corresponding class and a corresponding binary code. For example, binary vectors Iᵢ^{b}^{_{1 . . . K}}ε{0,1}^{N}^{ᵢ}^{x1} indicates those points that are associated with the class i and binary code b_{i . . . K}. Herein, the term class distribution may refer to a probability distribution associated with the plurality of classes, and accordingly the terms class distribution and probability distribution for the plurality of classes may be used interchangeably. In an embodiment, the processor 202 is configured to, with the content of the memory 204, and optionally with other components described herein, to cause the apparatus 200 to compute divergence between the class distributions based on the JSD measure. In an embodiment, a mapping may be determined between all non-zero probability subsets and the binary vectors of the binary matrix. For example,

$${p}_{i}^{{b}_{1 ⋯K} ⋂ {[ 1 ]}_{{h}_{l}}}$$

may be efficiently computed by counting “1” bits in the intersection of Iᵢ^{b}^{_{1 . . . K}} and corresponding Hᵢ column vectors, and thereafter normalizing the count with respect to Nᵢ. In an embodiment, the processor 202 is configured to, with the content of the memory 204, and optionally with other components described herein, to cause the apparatus 200 to determine the plurality of hash functions associated with the mapping.

In an embodiment, the JSD measure may be computed for the plurality of hash functions. In an embodiment, the processor 202 is configured to, with the content of the memory 204, and optionally with other components described herein, to cause the apparatus 200 to search the set of hash functions (h*ₗ) from among the plurality of hash functions such that JSD_{π}^{h}^{_{K}}^{∩h*}^{ₗ} is maximized. In an embodiment, the set of hash functions may be updated with the selected hash functions. An example algorithm for the LSH-JSD sequential learning is described as under:

```
Input: xₙ ε [symbol]    ^{NX p} , yₙ ε {0,1}^{M}, n=1, ....,N, K, L
begin
  h_{K} = Ø; Πᵢ = Nᵢ/N; I^{Ø}₁ =1^{N}ᵢ^{X1}, where Nᵢ := number of data points in class i;
  H = sgn (xW), where W=[w₁,...,w_{L}] ε [symbol]    ^{pXL} are random projections;
  for k=1, k≦K; k=k+1; do
    Compute JSD_{π}^{h}^{_{K}}^{∪h}^{ₗ} for all hₗ by looping
    for all b_{1...K} with pᵢ^{b}^{_{1...K}} ≠0 do
      Count “1” bits of Iᵢ^{b}^{_{1...K}}∩ Hᵢ ;
    end
    Search hₗ* such that JSD_{π}^{h}^{_{K}}^{∪h}^{ₗ}^{*} is maximized;
    Update H_{K} ← H _{K} ∪hₗ*
    Update Iᵢ^{b}^{_{1...K}} ;
  end
end
Output: H_{K} = {hₗ,...., hₖ}
```

In an embodiment, the class distribution may be limited by a threshold class distribution pₜ. In an embodiment, the processor 202 is configured to, with the content of the memory 204, and optionally with other components described herein, to cause the apparatus 200 to determine whether or not the class distribution pᵢ^{b}^{_{1 . . . K}} of a binary code is less than the threshold probability distribution pₜ. On determination of the class distribution pᵢ^{b}^{_{1 . . . K}} being less than the threshold probability distribution, the processor 202 is configured to, with the content of the memory 204, and optionally with other components described herein, to cause the apparatus 200 to terminate the computation of the JSD measure. In an embodiment, the mechanism similarity determination based on JSD measure may be implemented as a binary tree-growing algorithm. In an example embodiment, the number of bits “1” may be counted by using SSE4 instruction popcnt.

In an embodiment, the apparatus 200 facilitates in reducing the coding time by order of magnitudes by exploiting discriminative binary tests of input feature vectors. The term ‘coding time’ may be referred to as a time of converting a query data point associated with the data into binary codes. In an embodiment, the binary test may be performed to extract Haar-like features for real-time object detection. The Haar like features refers to digital image features associated with object detection and similarity determination. In terms of binary hash code, each Haar-like feature or weak classifier may be treated as a hash function with projection matrices applied to image pixel intensities. Herein, a set of Haar-Like Functions (HALF) may be represented as follows:

$${f}_{ij} ( x ) = \{ \begin{matrix}1 , & if {x}_{i} > {x}_{i} , i \neq j \\ 0 , & otherwise\end{matrix}$$

where, xᵢ is the i-th component of the input vector x=(x₁, x₂ . . . xₚ)ε [symbol] ^{p}.

In an embodiment, the family of hash functions hᵢⱼ(x) may constitute a subset of the linear projections that may include two non-zero elements (1 and −1 respectively) in each column of the projection matrix W. For p-dimensional input vectors, there may be total (₂^{p}) candidate HALFs from which K HALFs may be selected. In an embodiment, the JSD based binary code learning mechanism (denoted as rHALF-JSD) may be utilized to boost precision rates of random HALFs (rHALF).

In an embodiment, the processor 202 is configured to, with the content of the memory 204, and optionally with other components described herein, to cause the apparatus 200 to improve arbitrary binary code learning mechanisms. For example, the output Hₑε{0, 1}^{NXK} of the binary code learning mechanisms may be appended with the candidate binary matrix such that H←H∪Hₑ and the total probability of error may be computed (as discussed above).

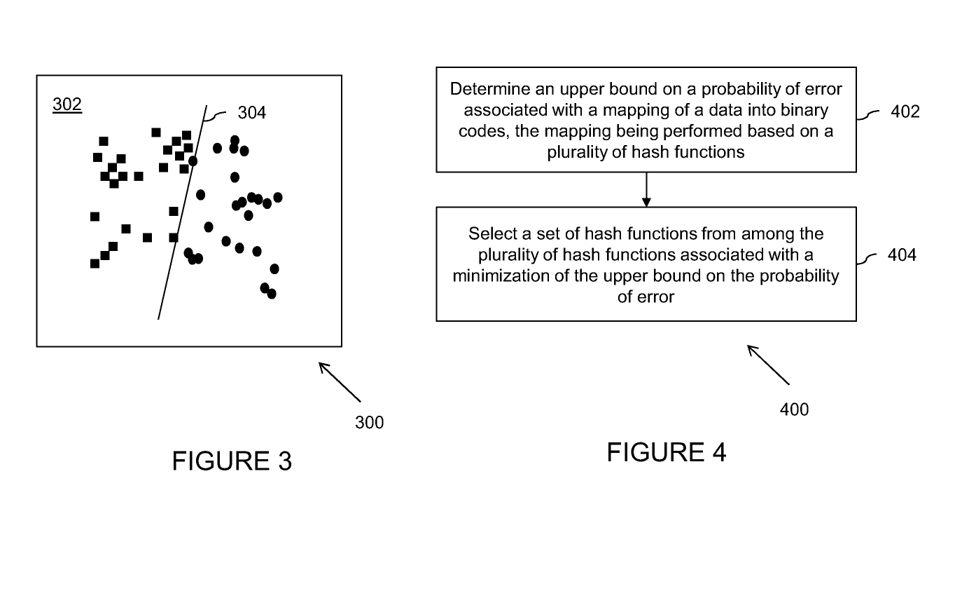

FIG. 3 illustrates example representation of similarity determination based on divergence measure, in accordance with an example embodiment. For example, a set of hash functions may be selected based on a JSD measure. As illustrated in FIG. 3, the partitioning of a sample space 302 based on a hash function selected by JSD measure is shown by a line 304.

FIG. 4 is a flowchart depicting example method 400 for similarity determination, in accordance with an example embodiment. The method 400 depicted in the flow chart may be executed by, for example, the apparatus 200 of FIG. 2.

In an embodiment, a data associated with a multimedia content may be received. In an embodiment, the data may be an image data. In an embodiment, the data may be required to be classified in a class from among a plurality of classes. In an embodiment, for classifying the data into a class, a learning model may be provided that may facilitate in correct classification of the data. In an embodiment, the method 400 includes determining a class associated with the data in a manner such that an error associated with classification of the data may be minimized. In an embodiment, the data may be mapped onto binary codes. In an embodiment, the mapping of the data onto binary codes may be performed based on a plurality of hash functions. In an embodiment, a set of hash functions may be determined from among the plurality of hash functions such that an error associated with the mapping may be minimized.

At block 402, the method 400 includes determining an upper bound on a probability of error associated with a probable mapping of the data into binary codes. In an embodiment, the error includes Bayes decision error. In an embodiment, determining the upper bound on the probability of error includes determining a total probability of error for the plurality of hash functions. The determination of the total probability of error based on the Bayes decision error for the plurality of hash functions is explained in detail in FIG. 2.

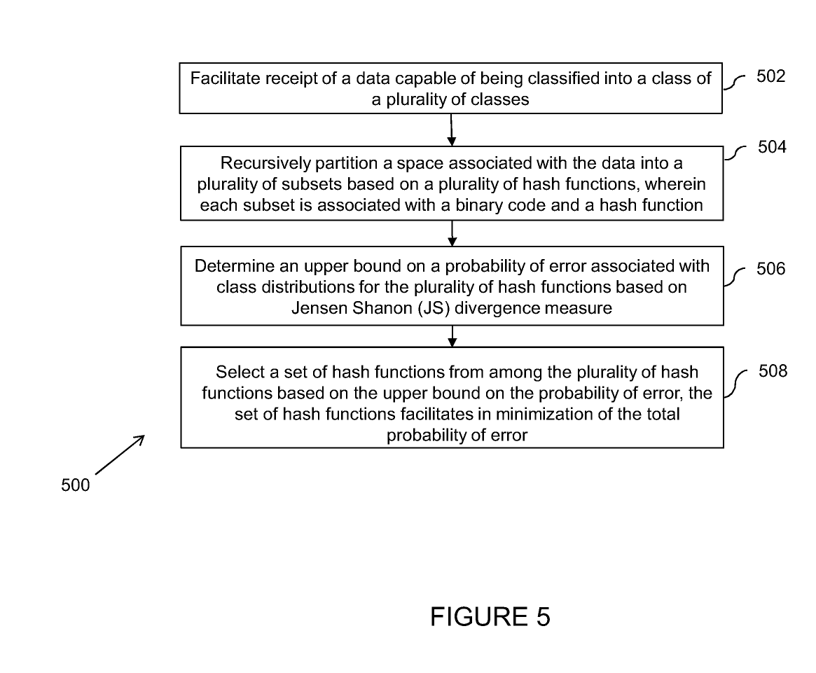

At block 404, a set of hash functions may be selected from among the plurality of hash functions associated with a minimization of the upper bound on the probability of error based on a divergence metrics. In an embodiment, the divergence metrics may include JS divergence measure. As discussed with reference to FIG. 2, a maximization of the JS divergence measure for the set of hash functions may facilitate in minimization of the upper bound on the error. A detailed flowchart describing a method for similarity determination based on the mapping of the data into binary codes is explained in FIG. 5.

FIG. 5 is a flowchart depicting an example method 500, in accordance with another example embodiment. The method 500 depicted in the flow chart may be executed by, for example, the apparatus 200 of FIG. 2. In various examples, the method 500 includes deriving a framework for binary hash code learning that may be associated with a minimal probability of error in similarity determination applications. In an embodiment, the framework facilitates in repeatedly evaluating and selecting hash functions with an objective to maximize a divergence measure between class distributions, and thereby achieving a minimal probability of error. In an embodiment, the divergence metrics includes JSD measure.

At block 502, the method 500 includes facilitating receipt of a data comprising a plurality of data points as independent observations. A data point of the plurality of data points may be represented as xᵢ. In an embodiment, the plurality of data points may be associated with multimedia content, such as images. In an embodiment, the method 500 also includes facilitating access of a plurality of probable classes into which the plurality of data points may be classified. For example, the data (x) may be associated with a class of M probable classes C₁, C₂, . . . C_{M}. In an embodiment, the priori probabilities associated with the classes C₁, C₂, . . . C_{M} may be π₁, π₂ . . . π_{M}, and probability density function associated with the classes may be given by p₁(x), p₂(x) . . . pₘ(x).

At block 504, a space (for example, a Euclidean space [symbol] ) associated with the data may be recursively partitioned into a plurality of subsets. In an embodiment, a plurality of hash functions may partition the space into a corresponding set of complementary subsets. For example, a plurality of (for example, K) hash functions may recursively partition the space associated with the data into a plurality (2^{K}) of non-overlapping subsets. In an embodiment, each subset of the plurality of subsets may be uniquely determined by a binary code and a partitioning hash function from among the plurality of hash functions.

At block 506, an upper bound on the total probability of error associated with class distributions for the plurality of hash functions may be determined. In an embodiment, the upper bound may be determined based on JS divergence. As discussed in FIG. 2, the probability of error the probability of error P(e) may be related to JSD measure as below:

$$P ( e ) \leq \frac{1}{2} ( H ( π ) - J S {D}_{π} ( {p}_{1} … , {p}_{M} ) )$$

$$where , \\ H ( π ) = - {\sum }_{i = 1}^{M} {π}_{i} ln {π}_{i} is the entropy of the priori probabilities , \\ and$$

$$J S {D}_{π} ( {p}_{1} … , {p}_{M} ) = H ( {\sum }_{i = 1}^{M} {π}_{i} {p}_{i} ) - {\sum }_{i = 1}^{M} {π}_{i} H ( {p}_{i} ) = {\sum }_{i = 1}^{M} {π}_{i} KL ( {p}_{i} \vert \vert \overline{p} )$$

At block 508, a set of hash functions may be selected from among the plurality of hash functions based on the upper bound on the total probability of error. In an embodiment, the set of hash functions facilitates in minimization of the total probability of error. For example, as explained with reference to FIG. 2, for a given set of hash functions H_{K}, the JSD measure may be in discrete form, and may be compounded by summing over all B-subsets:

$$J S {D}_{π} ( {p}_{1} … , {p}_{M} \vert {H}_{K} ) = {\sum }_{{b}_{1 … K} ∈ {D}_{{H}_{K}}} J S {D}_{π} ( {p}_{1}^{{b}_{1 … K}} , … {p}_{M}^{{b}_{1 … K}} )$$

$$where , \\ {p}_{1}^{{b}_{1 … K}} = {\int }_{{b}_{1 … K}} {p}_{i} ( x ) d x$$

In an embodiment, since H(π) is a constant for a given scenario, the upper bound of the probability of error may be minimized by maximizing equation (4):

H_{K}*=arg max_{H}_{_{K}}JSD_{π}(p₁ . . . p_{M}|H_{K})

In an embodiment, the framework for binary code learning disclosed with respect to method 500 may be utilized for supervising various binary hash code learning mechanisms. For example, the framework may be utilized for binary hash code learning with a dataset associated with multi-class labels. For example, at block 502 the method 500 may include accessing a multi-dimensional data (x) associated with multi-class labels. In an embodiment, the dataset (x) may contain N p-dimensional row vectors Xₙ as independent observations drawn from underlying multi-class distributions pᵢ. For example, the multi-dimensional image data may be represented by a dataset xε [symbol] ^{NX p} containing N p-dimensional row vectors xₙε [symbol] ^{1X p}, n=1, . . . , N as independent observations drawn from underlying multi-class distributions pᵢ. In an embodiment, the priori probabilities may be directly estimated as πᵢ=Nᵢ/N, where Nᵢ is the number of data points that belong to each class. For each data point, the associated class label yₙε{1, . . . , M} may be derived. In an example embodiment, the class label associated with the data points may be derived from Euclidean distance between the data points. In an alternative embodiment, the class label associated with the data points may be derived semantically, for example, provided by a user input.

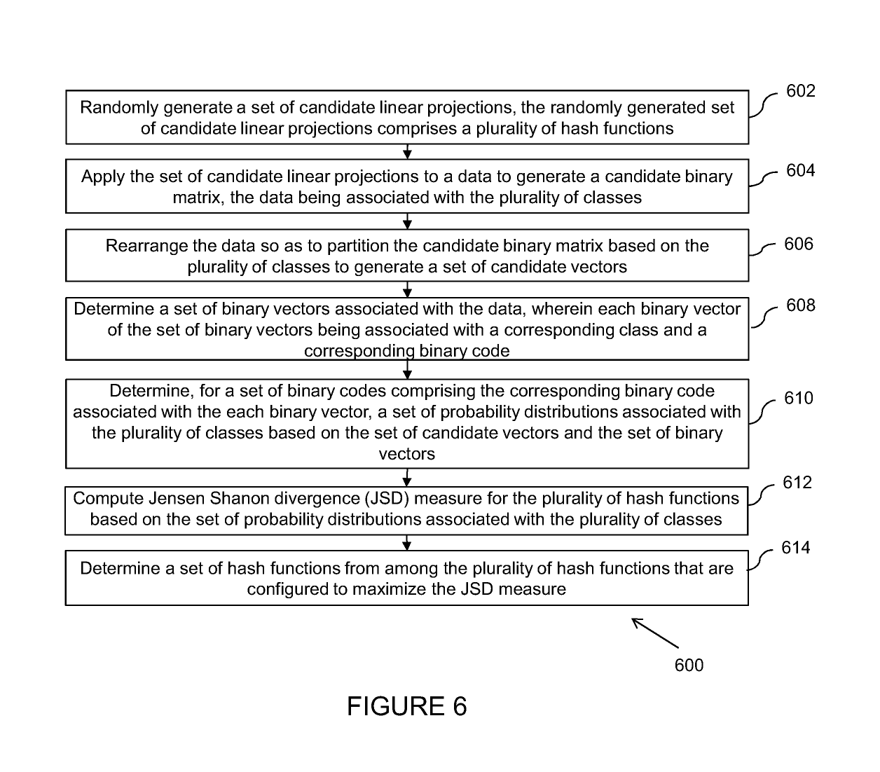

In an example embodiment, the framework for binary code learning disclosed with respect to method 500 may be utilized for supervising locality sensitive hashing (LSH) with sequential learning mechanism. A method for supervising LSH with binary code learning method may be explained in detail with reference to FIG. 6.

FIG. 6 is a flowchart depicting an example method 600 for similarity determination, in accordance with another example embodiment. In an embodiment, the method 600 facilitates in improving an output of similarity determination methods with labeled data. In an embodiment, the method facilities in supervising LSH with sequential learning mechanism disclosed with reference to FIG. 5. The method 600 depicted in the flow chart may be executed by, for example, the apparatus 200 of FIG. 2.

In an embodiment, an accuracy of the LSH method is determined by a probability that the LSH may find a correct nearest neighbor. In an embodiment, the method 600 facilitates in mapping a data onto binary codes in such a manner that a probability of error associated with mapping is minimized. In an embodiment, the probability of error is minimized by maximizing a divergence between probability distributions associated with a plurality of probable classes into which the data may be classified. In an embodiment, the divergence may be computed for a plurality of hash functions, and a set of hash may be selected from among the plurality of hash functions that may be associated with maximum divergence.

At block 602, the method 600 includes randomly generating a set of candidate linear projections. In an embodiment, the randomly generated set of candidate linear projections comprises a plurality of hash functions. At block 604, the set of candidate linear projections may be applied to a dataset, for example, a data h₁=sgn(xwₗ). In an embodiment, the data may be associated with a plurality of classes. In an embodiment, the outcome of the linear projections may be concatenated to generate a binary matrix Hε{0,1}^{NxL}

At block 606, the data (x) may be rearranged so as to partition the candidate binary matrix H based on the plurality of classes to generate a set of candidate vectors associated with the plurality of classes. For example, the data (x) may be rearranged according to the classes such that the binary matrix may be partitioned into separate matrices (or candidate vectors) Hᵢε{0,1}ᵢ^{NxL} for each class. At block 608, a set of binary vectors may be determined. The set of binary vectors may be feature vectors associated with the data. In an embodiment, each binary vector of the set of binary vectors may be indicative of a data point associated with a corresponding class i and a corresponding binary code b_{i . . . K}. At block 610, for a set of binary codes comprising the corresponding codes associated with the set of binary vectors, a set of probability distribution functions associated with the plurality of classes may be computed. In an embodiment, the probability distribution functions for the plurality of classes may be computed based on candidate vectors Hᵢ and corresponding binary vectors Iᵢ^{b}^{_{1 . . . K}}ε{0,1}^{N}^{ᵢ}^{x1}. For example,

$${p}_{i}^{{b}_{1 … K} ⋂ {[ 1 ]}_{{h}_{l}}}$$

may be computed by counting “1” bits in the intersection of the binary vector (Iᵢ^{b}^{_{1 . . . K}}) and corresponding Hᵢ (candidate vector), and thereafter normalizing the count with respect to Nᵢ.

At block 612, a divergence for the plurality of hash functions may be computed based on the probability distribution functions associated with the plurality of classes. In an embodiment, the divergence may be computed based on a JSD measure. The computation of the JSD measure is already explained with reference to FIG. 2. At block 614, a set of hash functions may be determined from among the plurality of hash functions that may be configured to maximize the JSD measure associated with the plurality of class distributions. Herein, the method 600 utilized a greedy approach to search new hash functions from among the plurality of hash functions. The use of random projections mitigates the risk and JSD-supervised approach significantly improves LSH performance, thereby precluding chances of getting stuck in local minima.

It should be noted that to facilitate discussions of the flowcharts of FIGS. 4, 5 and 6, certain operations are described herein as constituting distinct steps performed in a certain order. Such implementations are examples only and are non-limiting in scope. Certain operation may be grouped together and performed in a single operation, and certain operations can be performed in an order that differs from the order employed in the examples set forth herein. Moreover, certain operations of the methods 400, 500 and 600 are performed in an automated fashion. These operations involve substantially no interaction with the user. Other operations of the methods 400, 500 and 600 may be performed by in a manual fashion or semi-automatic fashion. These operations involve interaction with the user via one or more user interface presentations.

The methods depicted in these flow charts may be executed by, for example, the apparatus 200 of FIG. 2. Operations of the flowchart, and combinations of operation in the flowcharts, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the methods are described with help of apparatus 200. However, the operations of the methods can be described and/or practiced by using any other apparatus.

Without in any way limiting the scope, interpretation, or application of the claims appearing below, a technical effect of one or more of the example embodiments disclosed herein is to perform similarity determination in multimedia content such as images. Various embodiments provide techniques for formulating a binary hash coding learning framework within a statistical learning framework in which an upper bound of the probability of Bayes decision errors is derived for arbitrary hash functions Minimizing the upper bound for the hash code learning mechanisms leads to consistent performance improvements, regardless of whether the original mechanisms supervised or unsupervised. In various embodiments, the output of binary learning methods Hₑε{0,1}^{NXK} may be appended with the outcome of candidate random projection outcomes such that H←H∪Hₑ thereby leading to improvement in binary code learning methods.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

We claim:

1. A method comprising:
determining an upper bound on a probability of error associated with a mapping of a data into binary codes, the mapping being performed based on a plurality of hash functions; and
selecting a set of hash functions from among the plurality of hash functions associated with a minimization of the upper bound on the probability of error.

2. The method as claimed in claim 1, wherein the data comprises a multi-dimensional data and capable of being classified into a class of a plurality of classes.

3. The method as claimed in claim 1, further comprising recursively partitioning a space associated with the data into a plurality of subsets based on the plurality of hash functions, the plurality of subsets being associated with a corresponding binary code and a corresponding hash function.

4. The method as claimed in claim 2, wherein the upper bound being determined based on a Jensen Shanon Divergence (JSD) measure between probability distributions associated with the plurality of classes for the plurality of hash functions.

5. The method as claimed in claim 4, wherein the JSD measure being related with the probability of error based on following equation:
$$P ( e ) \leq \frac{1}{2} ( H ( π ) - J S {D}_{π} ( {p}_{1} … , {p}_{M} ) )$$
where, H(π) represents an entropy of priori probabilities associated with the plurality of classes.

6. The method as claimed in claim 5, wherein selection of the set of hash functions based on the JSD measure being configured to minimize the probability of error associated with the mapping.

7. The method as claimed in claim 4, further comprising:
applying a set of randomly generated candidate linear projections to the data to generate a candidate binary matrix, the randomly generated candidate linear projections comprises the plurality of hash functions;
rearranging the data to partition the candidate binary matrix based on the plurality of classes for generating a set of candidate vectors;
determining a set of binary vectors associated with the data, each binary vector of the set of binary vectors being associated with a corresponding class and a corresponding binary code;
determining, for a set of binary codes comprising the corresponding binary code associated with the each binary vector, a set of probability distributions associated with the plurality of classes based on the set of candidate vectors and the set of binary vectors;
computing the JSD measure for the plurality of hash functions based on the set of probability distributions associated with the plurality of classes; and
determining the set of hash functions from among the plurality of hash functions configured to maximize the JSD measure.

8. The method as claimed in claim 7, further comprising updating the candidate binary matrix by appending a binary matrix associated with a binary code learning mechanism to the candidate binary matrix.

9. An apparatus comprising:
at least one processor; and
at least one memory comprising computer program code, the at least one memory and the computer program code configured to, with the at least one processor, cause the apparatus to at least perform:
determine an upper bound on a probability of error associated with a mapping of a data into binary codes, the mapping being performed based on a plurality of hash functions; and
select a set of hash functions from among the plurality of hash functions associated with a minimization of the upper bound on the probability of error.

10. The apparatus as claimed in claim 9, wherein the data comprises a multi-dimensional data and capable of being classified into a class of a plurality of classes.

11. The apparatus as claimed in claim 9, wherein the apparatus is further caused, at least in part to:
recursively partition a space associated with the data into a plurality of subsets based on the plurality of hash functions, the plurality of subsets being associated with a corresponding binary code and a corresponding hash function.

12. The apparatus as claimed in claim 10, wherein the apparatus is further caused, at least in part to determine the upper bound based on a Jensen Shanon Divergence (JSD) measure between probability distributions associated with the plurality of classes for the plurality of hash functions.

13. The apparatus as claimed in claim 12, wherein the JSD measure being related with the probability of error based on following equation:
$$P ( e ) \leq \frac{1}{2} ( H ( π ) - J S {D}_{π} ( {p}_{1} … , {p}_{M} ) )$$
H(π) represents an entropy of priori probabilities associated with the plurality of classes.

14. The apparatus as claimed in claim 13, wherein the apparatus is further caused, at least in part to perform selection of the set of hash functions based on the JSD measure for minimizing the probability of error associated with the mapping.

15. The apparatus as claimed in claim 12, wherein the apparatus is further caused, at least in part to:
apply a set of randomly generated candidate linear projections to the data to generate a candidate binary matrix, the randomly generated candidate linear projections comprises the plurality of hash functions;
rearrange the data to partition the candidate binary matrix based on the plurality of classes for generating a set of candidate vectors;
determine a set of binary vectors associated with the data, each binary vector of the set of binary vectors being associated with a corresponding class and a corresponding binary code;
determine, for a set of binary codes comprising the corresponding binary code associated with the each binary vector, a set of probability distributions associated with the plurality of classes based on the set of candidate vectors and the set of binary vectors;
compute the JSD measure for the plurality of hash functions based on the set of probability distributions associated with the plurality of classes; and
determine the set of hash functions from among the plurality of hash functions configured to maximize the JSD measure.

16. The apparatus as claimed in claim 15, wherein the apparatus is further caused, at least in part to update the candidate binary matrix by appending a binary matrix associated with a binary code learning mechanism to the candidate binary matrix.

17. A computer program product comprising at least one computer-readable storage medium, the computer-readable storage medium comprising a set of instructions, which, when executed by one or more processors, cause an apparatus to at least perform:
determine an upper bound on a probability of error associated with a mapping of a data into binary codes, the mapping being performed based on a plurality of hash functions; and
select a set of hash functions from among the plurality of hash functions associated with a minimization of the upper bound on the probability of error.

18. The computer program product as claimed in claim 17, wherein the data comprises a multi-dimensional data and capable of being classified into a class of a plurality of classes.

19. The computer program product as claimed in claim 17, wherein the apparatus is further caused, at least in part to:
recursively partition a space associated with the data into a plurality of subsets based on the plurality of hash functions, the plurality of subsets being associated with a corresponding binary code and a corresponding hash function.

20. The computer program product as claimed in claim 18, wherein the apparatus is further caused, at least in part to determine the upper bound based on a Jensen Shanon Divergence (JSD) measure between probability distributions associated with the plurality of classes for the plurality of hash functions.

21. The computer program product as claimed in claim 20, wherein the JSD measure being related with the probability of error based on following equation:
$$P ( e ) \leq \frac{1}{2} ( H ( π ) - J S {D}_{π} ( {p}_{1} … , {p}_{M} ) )$$
H(π) represents the entropy of priori probabilities associated with the plurality of classes.

22. The computer program product as claimed in claim 20, wherein the apparatus is further caused, at least in part to:
apply a set of randomly generated candidate linear projections to the data to generate a candidate binary matrix, the randomly generated candidate linear projections comprises the plurality of hash functions;
rearrange the data to partition the candidate binary matrix based on the plurality of classes for generating a set of candidate vectors;
determine a set of binary vectors associated with the data, each binary vector of the set of binary vectors being associated with a corresponding class and a corresponding binary code;
determine, for a set of binary codes comprising the corresponding binary code associated with the each binary vector, a set of probability distributions associated with the plurality of classes based on the set of candidate vectors and the set of binary vectors;
compute the JSD measure for the plurality of hash functions based on the set of probability distributions associated with the plurality of classes; and
determine the set of hash functions from among the plurality of hash functions configured to maximize the JSD measure.
